(19) United States
(12) Patent Application Publication
(10) Pub. No.: US 2009/0152084 A1
(43) Pub. Date: Jun. 18, 2009

(54) SWITCH ASSEMBLY FOR HANDHELD POWER TOOL

(76) Inventors: Markus Hofer, Biezwil (CH); Hans Kaiser, Leuzigen (CH); Thomas Tschumi, Hessigkofen (CH)

Correspondence Address: MICHAEL J. STRIKER, 103 EAST NECK ROAD, HUNTINGTON, NY, 11743, US

(21) Appl. No.: 12/300,656

(22) PCT Filed: Oct. 24, 2007
(86) PCT No.: PCT/EP2007/061394

§ 371 Date: Nov. 13, 2008

(30) Foreign Application Priority Data
Dec. 22, 2006 (DE) 102006061246.9

(51) Int. Cl. H01H 13/00

(52) U.S. Cl. 200/329

(57) ABSTRACT

The invention originates from a machine tool switching device, in particular for a machine tool (12) for sawing, with a first operational control element (14) having at least one switching function for switching the machine tool (12). It is proposed that the machine tool switching device have at least one additional operational control element (16) which has at least the switching function of the first operational control element (14) for the switching of the machine tool (12).

### PRIOR ART

The invention is based on a switch assembly for a handheld power tool as generically defined by the preamble to claim 1.

A switch assembly for a handheld power tool, in particular for handheld power tools for sawing, is already known that has a user control element with at least one switching function for switching the handheld power tool.

### ADVANTAGES OF THE INVENTION

The invention is based on a switch assembly for a handheld power tool, in particular for a handheld power tool for sawing, having a first user control element with at least one switching function for switching the handheld power tool.

It is proposed that the switch assembly for a handheld power tool has at least one further user control element, which has at least the switching function of the first user control element for switching the handheld power tool, as a result of which an especially secure switching system with an at least partially redundant switching function of the handheld power tool can be achieved. Moreover, by means of the two user control elements, a switching system that is comfortable for a user can be implemented for switching the switching function of the handheld power tool, such as in working with a position of the handheld power tool which is located in a direction of gravity below a workpiece, and in which a tool of the handheld power tool is located on the handheld power tool counter to the direction of gravity. The switching function can be an ON/OFF switching function and/or other switching functions of the handheld power tool that appear useful to one skilled in the art; the first and further user control elements can each have additional switching functions that are different from one another. Preferably, the switch assembly for a handheld power tool is provided for switching a handheld power tool for sawing, such as a jigsaw in particular. In principle, the switch assembly for a handheld power tool can also be used in other handheld power tools that appear useful to one skilled in the art, such as right-angle sanders, and so forth. The switching of the two user control elements is effected especially advantageously by means of a sliding motion executed by a user. However, in principle, still other motion mechanisms that appear useful to one skilled in the art are conceivable at any time for switching a handheld power tool via the two user control elements, such as a tilting motion, and so forth.

It is also proposed that the handheld power tool has a synchronizing unit, which is provided for a synchronized course of motion of the two user control elements. As a result, it is possible in particular to attain the same switching position for the two user control elements, so that for instance by switching one of the two user control elements ON, both user control elements, by means of the synchronizing unit, are located in a switching position that is intended for switching the handheld power tool OFF.

It is furthermore proposed that the two user control elements are located on diametrically opposed sides of the synchronizing unit, as a result of which an especially advantageous, user-neutral switch assembly for a handheld power tool can be achieved. In particular, the handheld power tool, or the switch assembly for a handheld power tool, can be switched by means of the two user control elements, regardless of which hand a user chooses to use, such as whether he chooses his left or his right hand. Preferably, diametrically opposed sides of the synchronizing unit are located on diametrically opposed sides of a grip region of the handheld power tool, so that in a structurally simple way, comfortable switching of the switch assembly for a handheld power tool is made possible. This is achieved in particular in jobs done with the handheld power tool in which the handheld power tool is located in a direction of gravity below a workpiece, and a tool of the handheld power tool is located on the handheld power tool counter to the direction of gravity.

In an advantageous refinement of the invention, it is proposed that the synchronizing unit has at least one mechanical switch unit, as a result of which an economical switch assembly for a handheld power tool can advantageously be achieved. Especially advantageously, this can be achieved if the mechanical switch unit has at least one switch bracket, which connects the two user control elements to one another. In principle, however, still other embodiments of the synchronizing unit that appear useful to one skilled in the art are conceivable at any time, such as an electric switch unit, a magnetic switch unit, and so forth.

It is also proposed that the mechanical switch unit has at least one slide means, which is provided for transmitting force, as a result of which a structurally simple transmission of force from one of the user control elements to a further component can be achieved. Advantageously, the slide means of the switch assembly for a handheld power tool is located between at least one of the user control elements and a means provided for the switching.

It is moreover proposed that the mechanical switch unit has at least one switch means, which is operatively connected to a drive unit of a handheld power tool, as a result of which an advantageous cooperation can be achieved between the switch assembly for a handheld power tool and the drive unit. This can be achieved especially advantageously if the switch means is switchable via both user control elements.

In an advantageous refinement of the invention, it is proposed that the mechanical switch unit has at least one retention means, which is provided for securing the switch means to a switch unit of a handheld power tool, as a result of which an unwanted slipping of the mechanical switch unit of the switch assembly for a handheld power tool on a switch unit of the handheld power tool can be avoided.

### DRAWINGS

Further advantages will become apparent from the ensuing description of the drawings. In the drawings, one exemplary embodiment of the invention is shown. The drawings, description and claims include numerous characteristics in combination. One skilled in the art will expediently consider the characteristics individually as well and put them together to make useful further combinations.

Shown are:

FIG. 1, a switch assembly for a handheld power tool of the invention, in a perspective view; and

FIG. 2, a handheld power tool with the switch assembly for a handheld power tool of FIG. 1, in a top view.

### DESCRIPTION OF THE EXEMPLARY EMBODIMENT

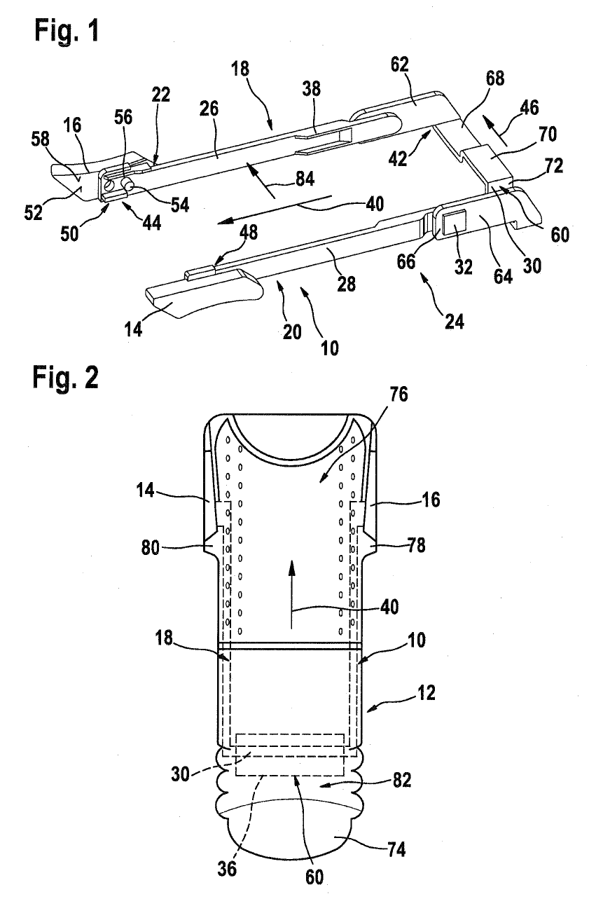

In FIG. 1, a switch assembly 10 for a handheld power tool of the invention is shown, which has two user control elements 14, 16. The two user control elements 14, 16 are connected to one another via a synchronizing unit 18. By means of the synchronizing unit 18, the user control elements 14, 16 have a synchronized course of motion, and are located in the same switching position for switching for a user.

The synchronizing unit 18 has a mechanical switch unit 24, by means of which switching or a switching motion of the switch assembly 10 for a handheld power tool, caused by an actuation of one of the two user control elements 14, 16, is transmitted by a user of the switch assembly 10 for a handheld power tool to a switch unit 36 of a handheld power tool 12 (FIG. 2). For that purpose, the mechanical switch unit 24 has a switch bracket 38, which connects the two user control elements 14, 16 to one another and thus makes a synchronized course of motion possible. The two user control elements 14, 16 are located on diametrically opposed sides 20, 22 of the synchronizing unit 18, in an extending direction 84 of the synchronizing unit 18, and the extending direction 84 is oriented perpendicular to the primary extending direction 40. The switch bracket 38 has a switch means 30 and has one slide means 26, 28 for each of the two user control elements 14, 16. The switch means 30 and the two user control elements 14, 16 are located in a primary extending direction 40 of the synchronizing unit 18 on opposite ends 42, 44 of the switch bracket 38. The switch means 30 and a primary extending direction 46 of the switch means 30 are oriented perpendicular to the primary extending direction 40 of the synchronizing unit 18; the primary extending direction 46 of the switch means 30 extends parallel to an imaginary shortest line between the two user control elements 14, 16. To attain a switching motion at the switch means 30 of the switch bracket 38, the switch means 30 is connected to the two user control elements 14, 16 by means of the two slide means 26, 28. The two slide means 26, 28 extend parallel to the primary extending direction 40 of the synchronizing unit 18 (FIG. 1).

Each of the user control elements 14, 16 is located at one of the ends 48, 50, diametrically opposed to the switch means 30, of the slide means 26, 28. Moreover, on a side 52 oriented toward the respective slide means 26, 28, the user control elements 14, 16 each have a detent element 54, which enters into a form-locking and force-locking connection with a detent element 56, corresponding to it, of the slide means 26, 28. The detent element 54 of the user control elements 14, 16 is formed by a boltlike extension, which is located perpendicular to a primary face 58 of the respective user control element 14, 16. The detent element 56 of the slide means 26, 28, corresponding to the detent element 54 of the user control element 14, 16, is formed for this purpose by a detent recess and is intended for receiving the detent element 54 of the user control element 14, 16 (FIG. 1). However, in principle, in an alternative embodiment of the switch assembly 10 for a handheld power tool, still other form-locking and/or force-locking and/or material-locking connections among the user control elements 14, 16 and the slide means 26, 28 that appear useful to one skilled in the art are also conceivable.

The switch means 30 of the switch bracket 38 has a middle switch region 60, oriented perpendicular to the primary extending direction 40 of the synchronizing unit 18, and also has two securing regions 62, 64, oriented parallel to the primary extending direction 40 of the synchronizing unit 18. The securing regions 62, 64 are located parallel to one another on opposite end regions of the middle switch region 60 of the switch means 30 and are embodied in one piece with the middle switch region 60. Moreover, the two securing regions 62, 64 each have a respective retention means 32, which is located on a side 66 of the securing regions 62, 64 that faces away from the slide means 26, 28 and is intended for securing the switch means 30 to the switch unit 36 of the handheld power tool 12. For that purpose, the retention means 32 are embodied in camlike fashion. On an end of the securing regions 62, 64 facing away from the middle switch region 60, these securing regions are each located on a respective slide means 26, 28 of the switch bracket 38.

The middle switch region 60 of the switch means 30 includes three portions 68, 70, 72; a middle portion 70 of the three portions is raised in steplike fashion relative to the other two portions 68, 72 (FIG. 1). By means of the steplike embodiment of the middle switch region 60, the switch unit 18 of the handheld power tool 12 is actuated, or in other words the handheld power tool 12 is switched on and off.

In FIG. 2, a handheld power tool 12 formed by a jigsaw, with a switch assembly 10 for a handheld power tool, is seen from above in a fragmentary view. The handheld power tool 12 includes a handheld power tool housing 74, which has a handgrip region 76, on a side oriented toward a tool, not shown in detail. The hand grip region 76 of the handheld power tool housing 74 has a recess on each of diametrically opposed housing walls 78, 80 of the handheld power tool housing 74; this recess is intended for receiving the user control element 14, 16 of the switch assembly 10 for a handheld power tool. By means of the two user control elements 14, 16, the handheld power tool 12, or a drive unit of the handheld power tool 12, is switched on and off by a user. When the handheld power tool 12 is switched on via one of the two user control elements 14, 16, the synchronizing unit 18 located inside the handheld power tool 12 causes both user control elements 14, 16 to be located in a switched-on switching position, and a user can use both user control elements 14, 16 for switching the handheld power tool 12 OFF. For switching the handheld power tool 12 on and off, the user control elements 14, 16 are thrust linearly forward or backward by a user in a primary extending direction 40 of the synchronizing unit 18.

On a side 82 of the handheld power tool 12 facing away from the tool, the switch means 30 of the switch assembly 10 for a handheld power tool is located inside the handheld power tool 12. The camlike retention means 32 (FIG. 1) connect the switch assembly 10 for a handheld power tool to the switch unit 36 of the handheld power tool 12, or to retention elements, not further shown, of the switch unit 36. The switch means 30 with the steplike switch region 60 is coupled to the switch unit 36. By means of the actuation or translational motion in the primary extending direction 40 of the synchronizing unit 18 of the user control elements 14, 16 by a user of the handheld power tool 12, a switching mechanism in a switch means of the switch unit 36 is tripped via the switch means 30 of the synchronizing unit 18, or the steplike switch region 60, and this mechanism leads to switching a drive unit, not shown in further detail, of the handheld power tool 12 on and off; the switch unit 36 is operatively connected to the drive unit.

1. A switch assembly for a handheld power tool, in particular for a handheld power tool (12) for sawing, having a first user control element (14) with at least one switching function for switching the handheld power tool (12), characterized by at least one further user control element (16), which has at least the switching function of the first user control element (14) for switching the handheld power tool (12).

2. The switch assembly for a handheld power tool as defined by claim 1, characterized by a synchronizing unit (18), which is provided for a synchronized course of motion of the two user control elements (14, 16).

3. The switch assembly for a handheld power tool as defined by claim 2, characterized in that the two user control elements (14, 16) are located on diametrically opposed sides (20, 22) of the synchronizing unit (18).

4. The switch assembly for a handheld power tool as defined by claim 2, characterized in that the synchronizing unit (18) has at least one mechanical switch unit (24).

5. The switch assembly for a handheld power tool as defined by claim 4, characterized in that the mechanical switch unit (24) has at least one switch bracket (38), which connects the two user control elements (14, 16) to one another.

6. The switch assembly for a handheld power tool as defined by claim 4, characterized in that the mechanical switch unit (24) has at least one slide means (26, 28), which is provided for transmitting force

7. The switch assembly for a handheld power tool as defined by claim 4, characterized in that the mechanical switch unit (24) has at least one switch means (30), which is operatively connected to a drive unit of a handheld power tool.

8. The switch assembly for a handheld power tool as defined by claim 7, characterized in that the switch means (30) is switchable via both user control elements (14, 16).

9. The switch assembly for a handheld power tool as defined by claim 4, characterized in that the mechanical switch unit (24) has at least one retention means (32), which is provided for securing the switch means (30) to a switch unit (36) of a handheld power tool (12).

10. A handheld power tool for sawing, having a switch assembly for a handheld power tool (10) as defined by claim 1.
